(19) United States
(12) Patent Application Publication
(10) Pub. No.: US 2026/0366356 A1
(43) Pub. Date: Nov. 19, 2026

(54) Arrangement of a leaf element on a body component for a motor vehicle, method, and motor vehicle

(71) Applicant: AUDI AG, Ingolstadt (DE)

(72) Inventor: Markus PETER, Reichertshofen (DE)

(73) Assignee: AUDI AG, Ingolstadt (DE)

(21) Appl. No.: 19/679,139

(22) Filed: May 15, 2026

(30) Foreign Application Priority Data
May 16, 2025 (DE) 10 2025 119 139.5

(51) Int. Cl. E05F 15/73; E05F 15/71

(52) U.S. Cl. CPC E05F 15/73; E05F 15/71; E05Y 2400/852; E05Y 2900/531

(57) ABSTRACT

An arrangement of a leaf element on a body component for a motor vehicle may include a drive device by which the leaf element is able to be driven. The drive device has a first detection device to detect a movement request from a person to move the leaf element by virtue of a detection of a manipulation of the leaf element by the person, intended to move the leaf element, the leaf element has a second detection device that is assigned to an operating point to detect the movement request from the person to move the leaf element by virtue of a detection of operation of the leaf element at the operating point by the person. An electronic computing device activates the drive device so as to drive the leaf element in a wind operating mode when the movement request is detected by the second detection device.

### CROSS-REFERENCE TO RELATED APPLICATIONS

This application claims the priority benefit of German Patent Application No. 10 2025 119 139.5 filed on May 16, 2025, which is incorporated by reference herein in its entirety.

### BACKGROUND

### Field

An invention according to described examples relates to an arrangement of a leaf element on a body component for a motor vehicle according to the claims. The invention according to the examples furthermore relates to a method for operating a motor vehicle according to the claims and to a motor vehicle according to the claims.

### Description of Related Art

Leaf elements for motor vehicles, such as for example side doors, are already well known from the general prior art. Such a side door may also be referred to simply just as a door. By way of example, an increasing number of motor vehicles are being given such conventional doors with an electric door drive. In the case of such a door drive, expansion stages may generally be servo-assisted actuation without obstacle detection, guided by a person, also referred to as a customer, at an operating point, such as for example a handle, or actuation through continuous actuation at the operating point, with for example no obstacle detection being provided in this case, meaning that the person designated as operator is responsible. Furthermore, such an expansion stage may be automatic actuation including obstacle detection, possibly with overriding by the person (customer intervention) if the side door moves too slowly or too fast. It is possible that at least partially or completely open side doors of the motor vehicle may be moved unintentionally by gusts of wind, in particular at least when a wind strength of the gust of wind is great enough to do so. In this case, for example, actively driven or actively braked doors in particular cannot distinguish between an intended customer actuation and the gust of wind, meaning that the side door may for example be unintentionally set in motion. As a result of the wind acting on the side door, the wind may for example unintentionally start a servo-assisted mode of the side door, also referred to as servo operation. In such a mode, for example, the door is normally guided actively by the user on the vehicle, as a result of which for example no active obstacle detection is provided for such a door, since the person is able to recognize such obstacles. In the extreme case, the door could collide with an obstacle if the wind were to move the door unintentionally as a result of unintended starting of the servo mode. This may result in damage to the side door or the obstacle. It is advantageous for servo forces provided by the drive device to be as low as possible for pleasant and comfortable haptics. This requirement may contradict a requirement with regard to the side door being held robustly in the event of wind, and it may thus be challenging to meet both requirements without additional measures.

DE 10 2019 121 640 A1 discloses a method for pivoting a movable door leaf of a door component for a motor vehicle with a drive device having an electric drive motor in order to influence pivoting of the door leaf at least partially between a closed position and an open position, wherein a position sensor is used to detect a position measure for an angular position of the door leaf and a speed characteristic for an angular speed of the door leaf. Provision is made in that case, when the door leaf is pivoted with the speed characteristic, to ascertain a predefined electric current strength for the electric drive motor and to set an associated predefined voltage and then to ascertain the current strength flowing through the drive motor, and for the predefined voltage to be increased if the current strength flowing through the drive motor is lower than the predefined electric current strength, and for the predefined voltage to be reduced if the current strength flowing through the drive motor is greater than the predefined electric current strength.

In addition, DE 10 2019 107 081 A1 discloses a driven vehicle door system for pivoting a vehicle door, relative to a vehicle body, out of a closed position into a partially open, presented position and for selectively holding the vehicle door in the presented open position, having a driven presenter arrangement that is mounted on the vehicle body and the vehicle door and has an extendable leaf element and a presenter actuator for actuating a movement of the extendable element between a retracted position, corresponding to the closed position of the vehicle door, and an extended position, corresponding to the partially open, presented position of the vehicle door. In that case, provision is made for a door control mechanism separate from the driven presenter arrangement, wherein the driven door control mechanism is mounted on the vehicle body and the vehicle door and has a control arm, and a control actuator designed to move the control arm between a non-engaged state and an engaged state.

### SUMMARY

The present invention according to described examples is based on an example object of providing an arrangement of a leaf element on a body component for a motor vehicle, a method for operating a motor vehicle, and a motor vehicle, such that it is possible to particularly increase safety with respect to damage to the leaf element.

The example object may be achieved by the subjects of the independent claims. Advantageous developments of the invention according to the examples may be described by the dependent claims, the following description and the figures.

A first aspect of the invention according to the examples relates to an arrangement of at least one leaf element on a body component for a motor vehicle or of the motor vehicle. The motor vehicle may be a motorized vehicle, in particular an automobile or a truck, or a minibus. The arrangement is understood to mean in particular a fastening arrangement, which may also be referred to as a holding arrangement. The body component is understood to mean in particular a component part of a body for the motor vehicle or of the motor vehicle. The body may be configured as a self-supporting body.

The leaf element is configured for example as a side door. As an alternative, the leaf element is configured for example as a hatch, in particular as a tailgate or engine hood.

The leaf element is held on the body component, in particular at least indirectly or directly, so as to be able to be moved, for example pivoted about a pivot axis, between a closed position, which closes off an opening, in particular completely, and at least one open position, which opens up the opening at least partially, in particular predominantly or completely. In other words, the leaf element is fastened to the body, in particular at least indirectly or directly, wherein the leaf element is able to be moved or is moved at least between the open position and the closed position. The movement of the leaf element is understood to mean in particular a movement of the leaf element relative to the body component. The movement of the leaf element between the open position and the closed position is understood to mean in particular a movement of the leaf element out of the open position into the closed position and/or out of the closed position into the open position.

The fact that the leaf element closes off the opening in the closed position is understood to mean in particular that, in the closed position, the leaf element covers the opening, for example, completely, for example in the vehicle transverse direction. The fact that the opening is at least partially opened up by the leaf element in the closed position is understood to mean in particular that, in the open position, the closure or covering of the opening is stopped, in particular at least in regions. By way of example, the opening is formed by the body. In other words, the body includes the opening, for example. By way of example, the body component includes the opening. In other words, the body component at least partially forms the opening, for example.

In particular when the leaf element is designed as a side door, the opening is designed for example as a door opening, via which for example an interior of the motor vehicle opens, in particular outwardly in the vehicle transverse direction, into surroundings of the motor vehicle, in particular at least when the leaf element is in the open position. The interior, which may also be referred to as a vehicle interior, is understood to mean in particular a passenger compartment or a passenger space. When the leaf element is in the open position, a person in the surroundings, that is to say in particular outside the motor vehicle, is able to enter the interior via the door opening. As an alternative or in addition, in the open position, a person in the interior is able to enter the surroundings via the door opening, that is to say leave the motor vehicle or get out of the motor vehicle. If the person is in the interior, the person may be referred to as a vehicle occupant. In the closed position, the person may be prevented from entering the interior from the surroundings via the door opening and/or from entering the surroundings from the interior via the door opening.

Provision is furthermore made for at least one, for example electric, drive device by way of which the leaf element is able to be driven or is driven so as to move between the open position and the closed position. This means that the drive device provides, or is able to provide, at least one force and/or at least one torque in order to move the leaf element, for example out of the open position and/or out of the closed position, in particular to pivot it about the pivot axis. The drive device may be referred to as a door drive. The drive device may be formed separately from the leaf element. The drive device may be designed as a servo drive, such that the drive device for example assists, in particular only assists, a movement of the side door carried out by the person, in particular out of the closed position and/or out of the open position, but the leaf element in particular cannot be driven or moved by the drive device without the cooperation of the person. Driving the leaf element by way of the drive device may thus assist the in particular manual movement of the leaf element by the person. As an alternative or in addition, it is possible for example for the leaf element to be able to be moved or to be moved between the open position and the closed position by way of the drive device, in particular without the cooperation of the person. The drive device may thus be intended to move the leaf element automatically, that is to say for example to automatically open and/or automatically close it.

The drive device has at least one first detection device that is designed to detect a movement request from the person to move the leaf element, by virtue of accompanying detection of a manipulation of the leaf element by the person, intended to move the leaf element, by way of the first detection device taking place. This means that the movement request is able to be detected or is detected by way of the first detection device, by virtue of the first detection device detecting the manipulation of the leaf element by the person.

The leaf element furthermore has an operating point, which is arranged in particular on an outer side of the leaf element, and a second detection device, which is assigned to the operating point, is formed separately from the first detection device, and is in particular spaced apart from the first detection device. The outer side of the leaf element is understood here to mean in particular an outer side that faces outward in the vehicle transverse direction with respect to the closed position. The second detection device is designed to detect the movement request from the person to move the leaf element, by virtue of accompanying detection of operation of the leaf element at the operating point by the person by way of the second detection device taking place. This means that the movement request is able to be detected or is detected by way of the second detection device, by virtue of the second detection device detecting the operation, caused by the person, of the leaf element at the operating point. The second operating point may be configured to not be part of the drive device.

In order to be able to particularly increase safety with respect to damage to the leaf element, provision is made for at least one electronic computing device that is configured, in a normal operating mode of the leaf element, when the movement request is detected by way of the first detection device, to activate the drive device so as to drive the leaf element, that is to say in particular so as to move the leaf element, for example out of the open position and/or out of the closed position. This means that, in the normal operating mode, that is to say when the leaf element is in the normal operating mode, when the movement request is detected by way of the first detection device, that is to say when the movement request is detected or has been detected by way of the first detection device, the drive device is able to be activated or is activated so as to drive the leaf element, and thereby in particular so as to move the leaf element, by way of the electronic computing device. In the normal operating mode, when the movement request is detected by way of the first detection device, in particular the accompanying movement of the leaf element thereby takes place, for example out of the open position into the closed position and/or out of the closed position into the open position, by way of the drive device, for example in servo mode or automatically. In other words, the electronic computing device causes the drive device to drive the leaf element, and thereby in particular move the leaf element, when, in the normal operating mode, the movement request is detected by way of the first detection device.

By way of example, the electronic computing device is configured, in the normal operating mode, when the movement request is detected by way of the second detection device, to activate the drive device so as to drive the leaf element, as a result of which, when the movement request is detected by way of the second detection device, in the normal operating mode, in particular the accompanying driving of the leaf element by way of the drive device takes place.

The electronic computing device is furthermore configured, in a wind operating mode of the leaf element that differs from the normal operating mode, when the movement request is detected by way of the second detection device, to activate the drive device so as to drive the leaf element, that is to say in particular so as to move the leaf element, for example out of the closed position and/or out of the open position. This means that, in the wind operating mode, that is to say when the leaf element is in the wind operating mode, when the movement request is detected by way of the second detection device, that is to say when the movement request is detected or has been detected by way of the second detection device, the drive device is able to be activated or is activated so as to drive the leaf element, and thereby in particular so as to move it for example between the open position and the closed position, by way of the electronic computing device. In the wind operating mode, when the movement request is detected by way of the second detection device, in particular the accompanying driving of the leaf element, that is to say in particular the movement of the leaf element, thereby takes place, for example out of the open position into the closed position and/or out of the closed position into the open position, by way of the drive device, for example in servo mode or automatically. In other words, in the wind operating mode, the electronic computing device causes the drive device to drive and thereby in particular move the leaf element when, in the wind operating mode, the movement request is detected by way of the second detection device. In the wind operating mode, the activation of the drive device so as to move the leaf element is prevented if, with respect to the first and the second detection device, the movement request is detected only by way of the first detection device. The movement of the leaf element, for example out of the open position and/or out of the closed position, is thereby in particular prevented. This means that, in the wind operating mode, the activation of the drive device so as to move the leaf element, and thereby in particular the movement of the leaf element by way of the drive device, is prevented if the movement request is detected by way of the first detection device and in particular the movement request is not detected by way of the second detection device. In other words, in the wind operating mode, the leaf element is able to be moved, that is to say for example opened or closed, only via the operating point or via the operation at the operating point, by way of the drive device, in relation to the manipulation of the leaf element by the person and the operation of the leaf element at the operating point.

By virtue of the fact that, in the wind operating mode, the drive device is not activated so as to move the leaf element or the movement of the leaf element by way of the drive device is prevented if, with respect to the first and the second detection device, the movement request is detected only by way of the first detection device, it is possible to prevent the leaf element from being moved unintentionally by the wind acting on the leaf element, that is to say for example from being moved unintentionally out of the open position or unintentionally out of the closed position. In this case, it is possible to prevent the wind from exerting a force on the leaf element and/or the wind, for example as a result of this force, from moving the leaf element, this force and/or this movement being recognized as a movement request by way of the first detection device, such that driving of the leaf element by way of the drive device is then prevented. The wind operating mode is thus for example a servo-operation of the drive device coupled to the operating point, in order for example to prevent the unintentional movement, in particular the unintentional opening and/or closing, of the leaf element caused by the wind. The wind operating mode accordingly makes it possible to prevent the leaf element from unintentionally colliding with an obstacle, as a result of which safety with respect to damage to the leaf element and/or safety with respect to damage to the obstacle is able to be particularly increased.

In order to be able to particularly increase safety with respect to damage to the leaf element with particularly little outlay, provision is made, in a further example, for at least one optical detection device for detecting the surroundings of the motor vehicle. This means that the surroundings are able to be detected or are detected, in particular optically, by way of the optical detection device. Furthermore, the electronic computing device is configured, on the basis of the detected environment, to ascertain, in particular calculate, at least one item of information that characterizes or describes the wind strength. This means that an item of information that characterizes the wind strength is able to be ascertained or is ascertained, in particular is able to be calculated or is calculated, by way of the electronic computing device on the basis of the detected surroundings. In other words, the electronic computing device uses the surroundings detected by way of the optical detection device as an input variable in order to ascertain an item of information that characterizes the wind strength as an output variable. This information may be referred to as wind strength information or as first information. The wind strength is understood to mean for example a wind speed of the wind blowing in particular in the surroundings and acting for example on the motor vehicle. Provision is furthermore made for an accompanying change of the leaf element from the normal operating mode to the wind operating mode, said change being brought about or intended to be brought about by way of the electronic computing device, to take place if the ascertained information or the ascertained first information deviates from a threshold value, which may be referred to as first threshold value, by more than a predefined degree. In other words, the accompanying change of the leaf element from the normal operating mode to the wind operating mode takes place if the ascertained information or first information is greater than or less than the first threshold value. For this purpose, the electronic computing device compares for example the ascertained information or the ascertained first information with the first threshold value, such that the electronic computing device checks, for example, whether the ascertained information or first information deviates from the threshold value or first threshold value by more than the predefined degree. The predefined degree may be referred to as the first predefined degree. The predefined degree is understood to mean in particular a previously defined degree. By virtue of the fact that the information is ascertained on the basis of the surroundings detected by way of the optical detection device, it is possible to dispense with a wind sensor, as a result of which in particular no wind sensor is required in the motor vehicle. In other words, the change to the wind operating mode works without a wind sensor, that is to say in particular without using such a wind sensor to detect wind or the wind strength of the wind. In this case, conventional vehicle sensor systems in the form of the optical detection device may be used to ascertain the wind strength or the first information. The optical detection device is configured for example as a camera or as a lidar sensor.

In order to be able to particularly increase safety with respect to damage to the leaf element with particularly little outlay, in a further example, provision is made for at least one precipitation sensor, in particular rain sensor and/or snow sensor, for detecting precipitation, in particular rain and/or snow. This means that the precipitation, that is to say in particular rain and/or snow, is able to be detected or is detected by way of the precipitation sensor. Furthermore, the electronic computing device is configured to ascertain, in particular calculate, an item of information that characterizes the precipitation intensity of the precipitation and is referred to for example as second information on the basis of the detected precipitation. This means that an item of information, or second information, that characterizes the precipitation intensity is able to be ascertained or is ascertained, in particular is able to be calculated or is calculated, by way of the electronic computing device on the basis of the detected precipitation. In other words, the electronic computing device uses the detected precipitation as an input variable in order to ascertain an item of information that characterizes the precipitation as an output variable. Provision is furthermore made for an accompanying change of the leaf element from the normal operating mode to the wind operating mode to take place if the ascertained information or second information deviates from a threshold value, which may be referred to as second threshold value or precipitation threshold value, by more than a predefined or previously defined degree, which may be referred to as a second degree. This means that the electronic computing device causes the leaf element to change from the normal operating mode to the wind operating mode if the ascertained second information deviates from the threshold value by more than the predefined second degree. In other words, the accompanying change of the leaf element from the normal operating mode to the wind operating mode takes place if the ascertained information or ascertained second information is greater than or less than the threshold value or second threshold value. The change to the wind operating mode is thus able to work without the wind sensor, as a result of which the wind sensor may be dispensed with. In this case, it is possible, by detecting the precipitation or by ascertaining an item of information that characterizes the precipitation, at least when this information deviates by the predefined second degree, to conclude from this that there is so much precipitation, that is to say that it is for example currently raining so heavily, that particularly strong wind is to be expected, as a result of which the wind sensor for directly detecting the wind may be dispensed with. It is thus possible to use a conventional vehicle sensor in the form of a precipitation sensor, such as for example a rain sensor, such that no in particular separate wind sensor is required.

In order to be able to particularly increase safety with respect to damage to the leaf element with particularly little outlay, in a further example, provision is made for at least one reception device for receiving the information or first information that characterizes the wind strength from at least one vehicle-external device. This means that an item of information that characterizes the wind strength is able to be received or is received by way of the reception device. Provision is accordingly made in particular for an item of information that characterizes the wind strength to be sent from the vehicle-external device, in particular to the motor vehicle. By way of example, the vehicle-external device is located in the surroundings of the motor vehicle and is in particular spaced apart from the motor vehicle. The vehicle-external device is for example a server that is for example able to be connected or is connected, in particular wirelessly, to the reception device of the motor vehicle so as to transmit data. The motor vehicle is thereby able for example to receive the first information from the Internet. Provision is made for the accompanying change of the leaf element from the normal operating mode to the wind operating mode to take place if the received information or first information deviates from the threshold value or first threshold value by more than the predefined or previously defined degree. This means that the electronic computing device causes the leaf element to change from the normal operating mode to the wind operating mode if the received information deviates from the threshold value by more than the predefined degree or the predefined first degree. In other words, the accompanying change of the leaf element from the normal operating mode to the wind operating mode takes place if the received information is greater than or less than the threshold value or first threshold value. It may thus be concluded, for example using weather forecasts from the vehicle-external device, that windy weather is present, as a result of which the leaf element should be put into the wind operating mode.

In order to be able to particularly increase safety with respect to damage to the leaf element with particularly little outlay, in a further example, provision is made for the electronic computing device to be configured to cause the change from the normal operating mode to the wind operating mode when an input device detects a user input from the person that characterizes the change request to the wind operating mode. This means that the change from the normal operating mode to the wind operating mode is able to be caused or is caused by way of the electronic computing device when the user input from the person by way of the input device, characterizing the change request to the wind operating mode, for example from the normal operating mode, is detected or has been detected. In other words, the accompanying change from the normal operating mode to the wind operating mode takes place when the user input from the person by way of the input device, characterizing the change request, is detected. The person may thereby be given the possibility of manually determining that the change from the normal operating mode to the wind operating mode should take place. The wind operating mode is thus able to be set manually by the person, for example. The input device is configured for example as a vehicle-internal input device. This means for example that the motor vehicle includes the input device. In this case, the input device is configured for example as a user interface of the motor vehicle. As an alternative, the input device is configured for example as a vehicle-external input device, such as for example as a mobile terminal, in particular belonging to the person. The mobile terminal is for example a cell phone, in particular a smartphone or a tablet, which may also be referred to as a tablet computer.

In order to be able to particularly increase safety with respect to damage to the leaf element with particularly little outlay, in a further example, the electronic computing device is configured, when the motor vehicle is stopped, to send, in particular to transmit, a display control signal to an output device in order, by way of the output device, to invite the person to change to the wind operating mode, in particular from the normal operating mode. This means that the display control signal is able to be sent or is sent, in particular is able to be transmitted or is transmitted, to the output device by way of the electronic computing device when the motor vehicle is stopped, that is to say when the motor vehicle has stopped, in order, by way of the output device, to invite the person to change to the wind operating mode, as a result of which the change to the wind operating mode is offered to the person in particular by way of the output device. In other words, when the display control signal is sent to the output device, accompanying outputting of at least one item of output information to the person by way of the output device takes place, in particular caused by this display control signal, wherein this output information describes the wind operating mode, in particular a possibility of changing to the wind operating mode from the normal operating mode. The person may thereby be made aware that it might make sense to change to the wind operating mode. In this case, the person may decide, for example at their own discretion, whether it is windy enough for such a change to make sense. It is possible to display a pop-up menu to the vehicle occupant, for example, when the motor vehicle is stopped by way of the output device, in particular by way of said invitation and/or by way of said output information. The output device may be configured as a vehicle-internal output device, that is to say as an output device of the motor vehicle. In this case, the output device is for example part of an infotainment system, such as for example of a screen. As an alternative, the output device is configured for example as a vehicle-external output device, that is to say for example as the abovementioned mobile terminal. The pop-up menu may thus be displayed, for example by way of a smartphone app, when the motor vehicle is stopped.

In a further example, provision is made for the movement request to be detected by way of the first detection device by virtue of the first detection device detecting a movement of at least one component of the drive device, for example relative to at least one second component of the drive device and/or relative to the body component, resulting from the manipulation of the leaf element by the person. In other words, when manipulating the leaf element, the person exerts at least one force, in particular directly, on the leaf element, wherein this force results in the movement of the at least one component of the drive device, and in the process in particular the movement of the leaf element, wherein the movement request is detected by way of the first detection device if the movement of the component, and thereby in particular the movement of the leaf element, is detected by way of the first detection device. In order to detect the movement request, it may thus be recognized, for example by way of the first detection device, that the leaf element starts to move, for example out of the open position or out of the closed position. The movement request is thereby able to be detected particularly precisely, such that for example comfort of the motor vehicle, in particular for the person when moving the leaf element, is able to be particularly increased.

As an alternative or in addition, provision is made, in a further example, for the movement request to be detected by way of the first detection device by virtue of the first detection device detecting a force resulting from the manipulation of the leaf element by the person and acting on the drive device, said force resulting for example in the abovementioned movement of the at least one component, and in particular the movement of the leaf element. In other words, the first detection device recognizes the movement request by detecting this force. The movement request may thereby be ascertained particularly precisely, as a result of which the comfort of the motor vehicle is able to be particularly increased.

In a further example, provision is made for the movement request to be detected by way of the second detection device by virtue of the second detection device detecting touching of the operating point by the person. In other words, the second detection device is configured as a touch-sensitive detection device and/or the operating point is configured as a touch-sensitive operating point. This means that the movement request is able to be detected or is detected by detecting touching of the operating point by the person by way of the second detection device. The movement request may thereby be detected particularly precisely, as a result of which comfort is able to be particularly increased.

As an alternative or in addition, in a further example, provision is made for the second detection device to detect a partially elastic deformation of the operating point resulting from the operation of the leaf element at the operating point by the person. In other words, the second detection device is configured as a deformation-sensitive detection device, such as for example as a strain gage, and/or the operating point is configured as a deformation-sensitive operating point. This means that the detection of the movement request is able to be brought about or is brought about by the detection of the deformation of the operating point by way of the second detection device. The movement request may thereby be ascertained particularly precisely, as a result of which comfort is able to be particularly increased.

A second aspect of the invention relates to a method for operating a motor vehicle, said motor vehicle in particular having an arrangement according to the first aspect of the invention. Advantages and advantageous examples of the first aspect of the invention are to be regarded as advantages and advantageous examples of the second aspect of the invention and vice versa.

The motor vehicle has at least one leaf element that is held on a body component so as to be able to be moved, for example pivoted about a pivot axis, between a closed position, which closes off the opening, and at least one open position, which opens up the opening at least partially. Furthermore, the motor vehicle has at least one drive device by way of which the leaf element is able to be driven or is driven so as to move between the open position and the closed position.

In order to be able to particularly increase safety with respect to damage to the leaf element, provision is made for a movement request from a person to move the leaf element to be detected by way of a first detection device of the drive device, by virtue of the detection device detecting a manipulation of the leaf element by the person, intended to move the leaf element. Furthermore, the movement request from the person to move the leaf element is detected by way of a second detection device of the leaf element assigned to the operating point of the leaf element, by virtue of operation of the leaf element at the operating point by the person being detected by way of the second detection device. In addition, the drive device is activated so as to drive the leaf element by way of an electronic computing device in a normal operating mode of the leaf element when the movement request is detected by way of the first detection device, as a result of which the leaf element is moved for example out of the open position and/or out of the closed position, in particular by way of the drive device. The drive device is activated so as to drive the leaf element by way of the electronic computing device in a wind operating mode of the leaf element that differs from the normal operating mode when the movement request is detected by way of the second detection device, as a result of which the leaf element is moved for example out of the open position and/or out of the closed position, in particular by way of the drive device. In the wind operating mode, the activation of the drive device so as to move the leaf element is prevented if, with respect to the first and the second detection device, the movement request is detected only by way of the first detection device, as a result of which in particular the movement of the leaf element by way of the drive device, for example out of the open position and/or out of the closed position, is prevented.

A third aspect of the invention according to the examples relates to a motor vehicle configured to carry out a method according to the second aspect of the invention according to the examples. This means that the motor vehicle is configured, in particular on a targeted basis, to carry out the method according to the second aspect of the invention according to the examples. Advantages and advantageous examples of the first and second aspect of the invention according to the examples are to be regarded as advantages and advantageous examples of the third aspect of the invention according to the examples and vice versa.

For application cases or application situations that may arise in the method and that are not described explicitly here, provision may be made, according to the method, for an error message and/or a request to input user feedback to be output and/or for a default setting and/or a predetermined initial state to be set.

The invention according to the examples also includes a control apparatus for the motor vehicle. The control apparatus is for example the electronic computing device. The control apparatus may have a data processing apparatus or a processor device (processor circuit) configured to carry out the method according to the examples of the invention. The processor device may, for this purpose, have at least one microprocessor and/or at least one microcontroller and/or at least one FPGA (field-programmable gate array) and/or at least one DSP (digital signal processor). In particular, a CPU (central processing unit), a GPU (graphical processing unit), or an NPU (neural processing unit) may each be used as a microprocessor. The processor device may furthermore have program code configured to carry out the method according to the examples of the invention when executed by the processor device. The program code may be stored in a data memory of the processor device. The processor device may be based for example on at least one circuit board and/or on at least one SoC (system on chip).

The invention according to the examples also includes developments of the method and motor vehicle according to the examples of the invention having features as have already been described in connection with the developments of the arrangement according to the examples of the invention. For this reason, the corresponding developments of the method and motor vehicle according to the examples of the invention will not be described again here.

As a further solution, the invention according to the examples also comprises a computer-readable storage medium comprising program code that, when executed by a computer or a computer network, causes it to carry out the method according to the examples of the invention. The storage medium may be provided at least partially as a non-volatile data memory (for example as a flash memory and/or as an SSD – solid state drive) and/or at least partially as a volatile data memory (for example as a RAM – random access memory). The storage medium may be arranged in the computer or computer network. The storage medium may however also be operated for example as a so-called app store server and/or cloud server on the Internet. A processor circuit containing for example at least one microprocessor may be provided by the computer or computer network. The program code may be provided as binary code and/or as assembler code and/or as source code of a programming language (for example C) and/or as a program script (for example Python). As an alternative, the computer-readable storage medium may be implemented by a signal containing computer-readable data, for example a time-varying voltage signal and/or a radio signal.

The invention according to the examples also comprises the combinations of the features of the examples described. The invention according to the examples thus also comprises implementations that each have a combination of the features of several of the examples described, unless the examples have been described as being mutually exclusive.

### BRIEF DESCRIPTION OF DRAWINGS

Examples of the invention will be described below. In the figures:

FIG. 1 shows a schematic plan view of a motor vehicle according to an example of the invention;

FIG. 2 shows a schematic front view of a leaf element of a motor vehicle according to an example the invention;

FIG. 3 shows a schematic illustration of a drive device for driving a leaf element of a motor vehicle according to an example the invention.

### DESCRIPTION

The examples explained below are examples of the invention. In the examples, the described components of the examples are each individual features of the invention according to the examples that should be considered independently of one another and that each also develop the invention according to the examples independently of one another. The disclosure is therefore also intended to comprise combinations of the features of the examples other than those illustrated. Furthermore, the described examples may also be supplemented by further features of the invention according to the examples that have already been described.

In the figures, identical reference signs denote functionally identical elements in each case.

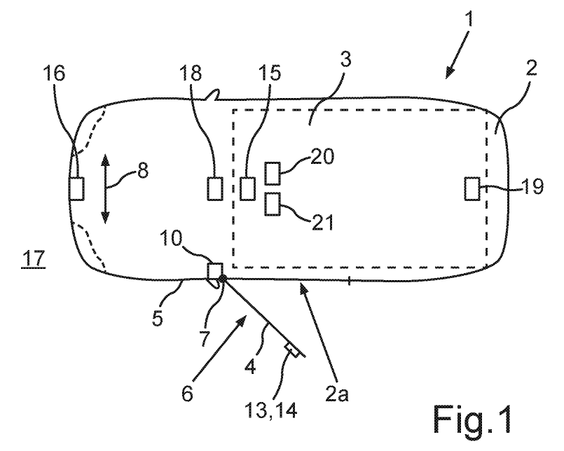

FIG. 1 shows a schematic plan view of a motor vehicle 1 having a body 2. The motor vehicle 1 furthermore has an interior 3 that may be delimited at least partially, in particular at least predominantly or completely, by the body 2. The motor vehicle 1 has at least one leaf element 4, which is configured as a side door in the example. However, the motor vehicle 1 may have a plurality of such leaf elements 4 or side doors, wherein the leaf element 4, which is configured for example as a front left side door of the motor vehicle 1, will be discussed below by way of example.

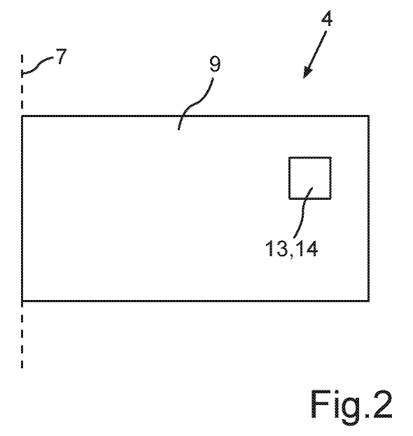

The leaf element 4 is arranged, in particular fastened, on the body 2, for example on a body component 5 of the body 2. The leaf element 4 is in this case held on the body 2, in particular on the body component 5, so as to be able to be moved, for example pivoted about a pivot axis 7, between a closed position, which closes off an opening 2a, in particular completely, and at least one open position 6, which at least partially opens up the opening 2a. For this purpose, for example, provision is made for a bearing device by way of which the leaf element 4 is fastened on the body component 5 so as to be able to be moved at least between the closed position and the open position 6. This bearing device is configured for example as a pivot bearing, in particular as a door hinge. FIG. 2 shows the leaf element 4 in a schematic front view, for example as seen from the outside in relation to a vehicle transverse direction 8 of the motor vehicle 1. By way of example, the leaf element 4 has a main body, which may be referred to as a base element or door body.

By way of example, the opening 2a, which may be referred to here as a door opening, is formed at least partially, in particular predominantly or completely, by the body 2, for example by a side frame of the body 2. By way of example, the side frame includes the opening 2a.

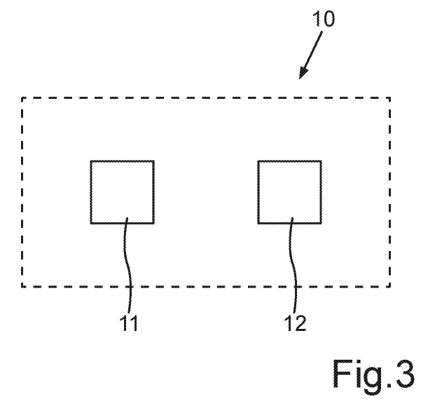

Furthermore, the motor vehicle 1 has a drive device 10, assigned in particular to the leaf element 4, by way of which the leaf element 4 is able to be driven or is driven, for example in a servo mode or fully automatically, so as to move between the open position 6 and the closed position. The drive device 10 is shown in a particularly schematic illustration in FIG. 3. By way of example, the drive device 10 has an electric machine 11 by way of which the driving or movement of the leaf element 4 is able to be brought about or is brought about. The drive device 10 is accordingly configured for example as an electric drive device 10.

As illustrated particularly schematically in FIG. 3, the drive device 10 has a first detection device 12 configured to detect a movement request from a person to move the leaf element 4, for example out of the open position 6 or out of the closed position, by virtue of accompanying detection of a manipulation of the leaf element 4 by the person, intended to move the leaf element 4, by way of the first detection device 12 taking place. By way of example, during the manipulation, the person holds the leaf element 4, in particular at any desired location, and in the process exerts a force on the leaf element 4 in order to move the leaf element 4 out of the closed position, that is to say for example move it out, or out of the open position 6, that is to say for example move it in. Such a manipulation may be detected or recognized by the first detection device 12 as the movement request. By way of example, the person moves, in particular pivots, the leaf element 4, in particular at least slightly, during the manipulation.

The leaf element 4 furthermore has an operating point 13, for example arranged on the main body 9. Furthermore, the leaf element 4 has a second detection device 14 that is assigned to the operating point 13 and that is formed in particular separately from the drive device 10, and thereby in particular separately from the first detection device 12, and that is configured to detect the movement request from the person to move the leaf element 4 by virtue of accompanying detection of in particular direct operation of the leaf element 4 by the person at the operating point 13 by way of the second detection device 14 taking place. In an example, the movement of the leaf element 4 by the person is prevented during this operation.

In order to be able to particularly increase safety with respect to damage to the leaf element 4, the motor vehicle 1 has an electronic computing device 15 by way of which, in a normal operating mode of the leaf element 4, when the movement request is detected by way of the first detection device 12, and in particular when the movement request is detected by way of the second detection device 14, the drive device 10, in particular the electric machine 11, is able to be activated or is activated so as to drive the leaf element 4, as a result of which in particular the accompanying movement of the leaf element 4 takes place, for example out of the open position 6 or out of the closed position. Therefore, in the normal operating mode, the driving of the leaf element by way of the drive device 10, that is to say for example the initiation of the servo operation, also referred to as the servo mode, does not necessarily have to pass via the operating point 13, but also for example through the abovementioned manipulation of the leaf element 4 by the person, for example on at least one further region of the leaf element 4, in particular of the main body 9, different from the operating point 13, in particular spaced apart from the operating point 13. The person, also referred to as the user, may thus for example hold the leaf element 4 at any desired location in the normal operating mode and move it in or out, and thus for example move the leaf element 4 in the servo mode, also referred to as servo operation. The electronic computing device 15 is furthermore configured, in a wind operating mode of the leaf element 4 that differs from the normal operating mode, when the movement request is detected by way of the second detection device 14, to activate the drive device 10, in particular the electric machine 11, so as to drive the leaf element 4, as a result of which in particular the accompanying movement of the leaf element 4 takes place, for example out of the open position 6 or out of the closed position. In the wind operating mode, the activation of the drive device 10 so as to move the leaf element 4 is prevented, as is thereby in particular the movement of the leaf element 4, for example out of the open position 6 or out of the closed position, by way of the drive device 10 if, with respect to the first and the second detection device 12, 14, the movement request is detected only by way of the first detection device 12. This means that, in the wind operating mode, the driving of the leaf element 4 by the drive device 10 is prevented if the movement request is not detected by way of the second detection device 14. It is thereby possible, in the wind operating mode, to avoid the first detection device 12 detecting an erroneous movement request that is or has been caused by the wind acting on the leaf element 4. An unintentional movement of the leaf element 4 brought about by way of the drive device 10 is thereby able to be avoided particularly reliably.

The electronic computing device 15 may be able to be coupled or is coupled to the detection devices 12, 14 and to the drive device 10, in particular the electric machine 11, so as to transmit data. In order to bring about the activation of the drive device 10, the electronic computing device 15 sends, in particular transmits, for example at least one control signal to the drive device 10, in particular to the electric machine 11. This control signal in particular describes or contains a movement that is to be carried out or is carried out by the drive device 10, such as for example the movement of the leaf element 4 out of the open position 6 into the closed position and/or out of the closed position into the open position 6.

The motor vehicle 1 may have at least one optical detection device 16 for detecting surroundings 17 of the motor vehicle 1. The optical detection device 16 is configured for example as a camera or as a lidar sensor. Furthermore, in the present case, the electronic computing device 15 is configured to ascertain an item of information that characterizes the wind strength on the basis of the detected surroundings 17, wherein an accompanying change of the leaf element from the normal operating mode to the wind operating mode takes place if this ascertained information deviates from a threshold value by more than a predefined or previously defined degree. For this purpose, the electronic computing device 15 is coupled to the optical detection device 16, in particular so as to transmit data. The wind operating mode, also referred to as wind mode, may thus be set automatically by the motor vehicle 1 if for example any other sensor system in the motor vehicle 1 in the form of the optical detection device 16, that is to say for example an optical system, such as a camera or lidar or the like, is used to detect whether wind is blowing or gusting in the surroundings 17. In this case, the optical detection device 16 may be used for example to recognize whether objects located in the surroundings 17, such as for example trees, are moving in the wind. The predetermined degree may be zero or greater than 0.

The motor vehicle 1 may have a precipitation sensor for detecting precipitation, such as for example rain or snow. The precipitation sensor 18 may accordingly be referred to as a rain sensor and/or snow sensor, for example. The precipitation sensor 18 is in particular able to be coupled or is coupled to the electronic computing device 15 so as to transmit data. In the present case, the electronic computing device 15 is configured to ascertain an item of information that characterizes the precipitation intensity of the precipitation on the basis of the detected precipitation, wherein the accompanying change of the leaf element 4 from normal operating mode to the wind operating mode takes place if this ascertained information deviates from a threshold value by more than a predefined degree. This predefined degree may be referred to as a second predefined degree, which is for example zero or greater than zero. This threshold value may be referred to as a second threshold value. The wind operating mode may thus be set automatically by the motor vehicle 1 for example when the rain sensor is active and it may in particular be assumed that, in addition to rain, there is also some wind in the surroundings 17. The information that characterizes the precipitation intensity is detected based for example on the fact that the precipitation sensor 18 detects that the precipitation has wetted at least one surface of the motor vehicle 1. By way of example, an exact amount of precipitation is thus not necessarily measured, but rather secondary effects such as wetting or visual obstruction of a rainy window are registered, for example. By way of example, the precipitation sensor 18 is arranged in the region of a windshield, in particular on the windshield, of the motor vehicle 1.

In an example, the motor vehicle 1 has a reception device 19 for receiving the information that characterizes the wind strength from a vehicle-external device, wherein the accompanying change of the leaf element 4 from the normal operating mode to the wind operating mode takes place if the received information deviates from the threshold value by more than the predefined degree. For this purpose, the reception device 19 is able to be coupled or is coupled to the electronic computing device 15, in particular so as to transmit data. The wind operating mode may thereby for example be set automatically by the motor vehicle 1 if the motor vehicle 1 is able to conclude, on the basis of the information available thereto in the meantime via services, such as optionally Connect and/or other online services, that it is windy or will be windy in the surroundings 17.

In an example, the electronic computing device 15 is configured to cause the change from the normal operating mode to the wind operating mode when an input device 20 detects a user input from the person that characterizes the change request to the wind operating mode. In this case, the input device 20 is configured for example as a vehicle-internal input device that is for example part of an infotainment system of the motor vehicle 1. As an alternative, the input device 20 is configured for example as a mobile terminal belonging to the person. The wind operating mode may thus be set for example at any time by the person, also referred to as the user, in particular manually, for example if the person wants the servo operation generally to work only via the provided operating point 13, who may select this accordingly in the configuration options, for example in at least one menu of the infotainment system. Independently of the wind, for example, the servo operation is then possible only via the operating point 13 provided for this purpose. For certain groups of people who for example have to support themselves somewhat on open or partially open side doors when getting in or when getting out, it may be quite particularly advantageous for the side door to become somewhat more stable and not to go into servo operation and thereby move in the event of any movement. As an alternative or in addition, the wind mode may for example be set at any time by the person if this is triggered actively by the person using a smartphone or other mobile terminals connected to the motor vehicle 1, or the person may receive a push message, optionally when approaching the motor vehicle 1, on the basis of available information.

Furthermore, provision is made in part for the electronic computing device 15 to be configured to send a display control signal to an output device 21 when the motor vehicle 1 has stopped in order to invite the person to change to the wind operating mode by way of the output device 21. In this case, the output device 21 may for example visually display a message, for example in the form of a pop-up menu and/or in the form of the abovementioned push message, to the person. As an alternative, it is possible for the output device 21 to query such a push message when the person approaches the motor vehicle 1. The wind operating mode may thus for example be set by the person at any time when the motor vehicle 1 has stopped, and it may for example be assumed that the leaf element is potentially to be moved, that is to say opened or closed, for example, with this stopping of the motor vehicle 1. In this case, the person may be offered the possibility by the output device 21 for the leaf element 4 to change to the wind operating mode, for example from the normal operating mode. This allows the customer to be offered the option of the wind operating mode optionally via a pop-up menu. The output device 21 may be configured as a vehicle-internal output device, which is for example part of the infotainment system. As an alternative, the output device 21 is configured for example as a vehicle-external device, such as for example as the mobile terminal belonging to the person.

The movement request is detected by way of the first detection device 12, for example by virtue of the first detection device 12 detecting a movement of at least one component of the drive device 10, in particular of the electric machine 11, resulting from the manipulation of the leaf element 4 by the person, and/or the first detection device 12 detecting the force resulting from the manipulation of the leaf element 4 by the person and acting on the drive device 10, in particular the electric machine 11. In other words, the detection of the movement request by way of the first detection device is based on the detection of the movement and/or of the force acting on the drive device 10. This is understood to mean in particular that the first detection device 12 detects at least one variable that characterizes the movement of the component and/or force acting on the drive device 10 and ascertains, in particular calculates, the movement request on the basis of this detected variable, that is to say in particular from this variable or by using this variable as an input variable. Accordingly, the abovementioned detection of the movement request by way of the first detection device 12 may be understood to mean in particular this ascertaining of the movement request.

By way of example, provision is made for the movement request to be detected by way of the second detection device 14 by virtue of the second detection device 14 detecting touching of the operating point 13 by the person, for example inductively, and/or the second detection device detecting a deformation of the operating point 13 resulting from the operation of the leaf element 4 at the operating point 13 by the person. In other words, the detection of the movement request by way of the second detection device 14 is based on the second detection device 14 detecting touching of the operating point and/or detecting the deformation of the operating point 13 caused by the person. This is understood to mean in particular that the second detection device 14 detects at least one variable that characterizes the touching of the operating point carried out by the person and/or the deformation of the operating point 13 caused by the person and ascertains, in particular calculates, the detection of the movement request on the basis of this detected variable, that is to say in particular from this detected variable or by using this detected variable as an input variable. Accordingly, detecting the movement request with the second detection device is understood to mean in particular this ascertaining of the movement request by way of the second detection device 14.

Overall, the examples show how an electric door drive or a leaf element 4 is able to be realized in a wind mode.

A description has been provided with particular reference to examples, but it will be understood that variations and modifications can be effected within the spirit and scope of the claims, which may include the phrase "at least one of A, B and C" as an alternative expression that refers to one or more of A, B or C, contrary to the holding in Superguide v. DIRECTV, 358 F3d 870, 69 USPQ2d 1865 (Fed. Cir. 2004).

1. A system for a leaf element on a body component for a motor vehicle, in which the leaf element is held on the body component so as to be able to be moved between a closed position, which closes off an opening, and at least one open position, which at least partially opens up the opening, comprising:
a drive device configured to drive the leaf element so as to move the leaf element between the at least one open position and the closed position,
the drive device has a first detection device configured to detect a movement request from a person to move the leaf element, based upon a detection, by the first detection device, of a manipulation of the leaf element by the person intending to move the leaf element,
a second detection device assigned to an operating point of the leaf element and configured to detect a movement request to move the leaf element, based on a detection, by the second detection device, of operation of the leaf element at the operating point by the person, and
an electronic computing device configured to, in a normal operating mode of the leaf element, when the movement request is detected by the first detection device, to activate the drive device so as to drive the leaf element and, in a wind operating mode of the leaf element that differs from the normal operating mode, when the movement request is detected by the second detection device, to activate the drive device so as to drive the leaf element, wherein, in the wind operating mode, activation of the drive device so as to move the leaf element is prevented if, with respect to the first detection device and the second detection device, the movement request is detected only by the first detection device.

2. The system according to claim 1, further comprising an optical detection device configured to detect surroundings of the motor vehicle,
wherein the electronic computing device is configured to ascertain an item of information that characterizes a wind strength on basis of the detected surroundings, so that a change of the leaf element from the normal operating mode to the wind operating mode takes place if the ascertained information deviates from a threshold value by more than a defined degree.

3. The system according to claim 1, further comprising a precipitation sensor configured to detect a precipitation,
wherein the electronic computing device is further configured to ascertain an item of information that characterizes a precipitation intensity of the precipitation on basis of the detected precipitation, so that change of the leaf element from the normal operating mode to the wind operating mode takes place if the ascertained information deviates from a threshold value by more than a defined degree.

4. The system according to claim 1, further comprising a reception device configured to receive an item of information that characterizes a wind strength from a vehicle-external device, so that a change of the leaf element from the normal operating mode to the wind operating mode takes place if the received information deviates from a threshold value by more than a defined degree.

5. The system according to claim 1, wherein the electronic computing device is configured to cause a change from the normal operating mode to the wind operating mode when an input device detects a user input from the person that characterizes a change request to the wind operating mode.

6. The system according to claim 1, wherein the electronic computing device is configured to send a display control signal to an output device when the motor vehicle has stopped to invite the person to change to the wind operating mode.

7. The system according to claim 1, wherein
the movement request is detected by the first detection device based on detecting a movement of at least one component of the drive device resulting from the manipulation of the leaf element by the person and/or the first detection device detecting a force resulting from the manipulation of the leaf element by the person and acting on the drive device.

8. The system according to claim 1, wherein
the movement request is detected by the second detection device based on detecting touching of the operating point by the person and/or the second detection device detecting a deformation of the operating point resulting from the operation of the leaf element at the operating point by the person.

9. A method of operating a motor vehicle, in which the motor vehicle has at least one leaf element that is held on a body component so as to be able to be moved between a closed position, which closes off an opening, and at least one open position, which at least partially opens up the opening, and at least one drive device by way of which a leaf element of the at least one leaf element is able to be driven so as to move between the at least one open position and the closed position, comprising:
detecting, by a first detection device of a drive device of the at least one drive device, a movement request from a person to move a leaf element of the at least one leaf element , based on the first detection device detecting a manipulation of the leaf element by the person intending to move the leaf element,
detecting, by a second detection device of the leaf element assigned to an operating point of the leaf element, a movement request to move the leaf element, based on operation of the leaf element at the operating point, by the person, being detected by the second detection device, and
by an electronic computing device configured to execute a process including,
activating the drive device to drive the leaf element in a normal operating mode of the leaf element when the movement request is detected by the first detection device, and
activating the drive device to drive the leaf element in a wind operating mode of the leaf element that differs from the normal operating mode when the movement request is detected by the second detection device, wherein, in the wind operating mode, the activating of the drive device so as to move the leaf element is prevented if, with respect to the first detection device and the second detection device, the movement request is detected only by the first detection device.

10. A motor vehicle configured with at least one leaf element that is held on a body component so as to be able to be moved between a closed position, which closes off an opening, and at least one open position, which at least partially opens up the opening, and at least one drive device by way of which a leaf element of the at least one leaf element is able to be driven so as to move between the at least one open position and the closed position, and configured to execute a process comprising:
detecting, by a first detection device of a drive device of the at least one drive device, a movement request from a person to move the leaf element, based on the first detection device detecting a manipulation of the leaf element by the person intending to move the leaf element,
detecting, by a second detection device of the leaf element assigned to an operating point of the leaf element, a movement request to move the leaf element, based on operation of the leaf element at the operating point, by the person, being detected by the second detection device, and
by an electronic computing device configured to execute a process including,
activating the drive device to drive the leaf element in a normal operating mode of the leaf element when the movement request is detected by the first detection device, and
activating the drive device to drive the leaf element in a wind operating mode of the leaf element that differs from the normal operating mode when the movement request is detected by the second detection device, wherein, in the wind operating mode, the activating of the drive device so as to move the leaf element is prevented if, with respect to the first detection device and the second detection device, the movement request is detected only by the first detection device.
